(19) United States
(12) Patent Application Publication
(10) Pub. No.: US 2009/0003011 A1
(43) Pub. Date: Jan. 1, 2009

(54) Fairy lights

(76) Inventor: Kuo-Hao Huang, Taipei (TW)

Correspondence Address: COOPER & DUNHAM, LLP, 1185 AVENUE OF THE AMERICAS, NEW YORK, NY, 10036, US

(21) Appl. No.: 11/823,750

(22) Filed: Jun. 28, 2007

(51) Int. Cl. F21S 13/14; F21S 4/00; F21V 7/00

(52) U.S. Cl. 362/566; 362/235; 362/252

(57) ABSTRACT

Fairy lights have at least one light assembly connected to a wire cable. Each light assembly has at least one shell, a film attached to the at least one shell and at least one lighting device. The film has a mounting ring and multiple branches radially extend outward from the mounting ring, and may be coated with a reflective layer and have optical fibers arbitrarily mounted on the branches. When changing the branches to different shapes, the film is formed to have a particular pattern. With the films, the light string generates festinating decorative effects when the light assembly is activated.

### BACKGROUND OF THE INVENTION

1. Field of the Invention

The present invention relates to fairy lights, and more particularly to fairy lights have at least one light assembly, wherein the light assembly includes a film mounted between two shells or attached to a single shell to provide enhanced decorative effects.

2. Description of Related Art

Business shops, department stores and even ordinary houses may use lighting ornaments for decoration during major festivals. One of the conventional lighting ornaments is manufactured as a ball-like shape and can be hung on trees, windows or other places. Such a ball-like lighting ornament has a relatively simple structure with a shell in which a lighting device is mounted to generate light. However, these ball-like lighting ornaments lack strong attraction due to their featureless appearances.

To overcome the foregoing shortcomings, the present invention provides fairy lights to mitigate or obviate the aforementioned problems.

### SUMMARY OF THE INVENTION

The main objective of the invention is to provide fairy lights with enhanced decorative effects.

The fairy lights have a least one light assembly connected to a wire cable. The light assembly has two shells, a film mounted between the two shells and at least one lighting device. The film has a mounting ring and multiple branches radially extending outward from the mounting ring, and may be coated with a reflective layer and have optical fibers mounted on the branches. When changing the branches to different shapes, the film is formed to have a particular pattern. With the films, the fairy lights generate fascinating decorative effects when the light assemblies are activated

Alternatively, the light assembly has a single shell, a film mounted to the the single shell, and at least one lighting device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of fairy lights composed of multiple light assemblies of a first embodiment in accordance with the present invention;

FIG. 2 is an exploded perspective view of the light assembly of the first embodiment in FIG. 1;

FIG. 3 is a perspective view of the light assembly of the first embodiment in FIG. 1;

FIG. 4 is a front view of a second embodiment of a film in accordance with the present invention;

FIG. 5 is a front view of a third embodiment of a film in accordance with the present invention;

FIG. 6 is a front view of a fourth embodiment of a film in accordance with the present invention;

FIG. 7 is an enlarged exploded view of the parts of the first embodiment in FIG. 1;

FIG. 8 is an exploded perspective view of the light assembly having a second embodiment of two shells in accordance with the present invention;

FIG. 9 is a front view in partial section of two shells engaging with a film in accordance with the present invention;

FIG. 10 is a top cross sectional view of the two shells being engaged with the film in accordance with the present invention;

FIG. 11 is an operational view of the fairy lights with one single shell in accordance with the present invention.

### DETAILED DESCRIPTION OF PREFERRED EMBODIMENT

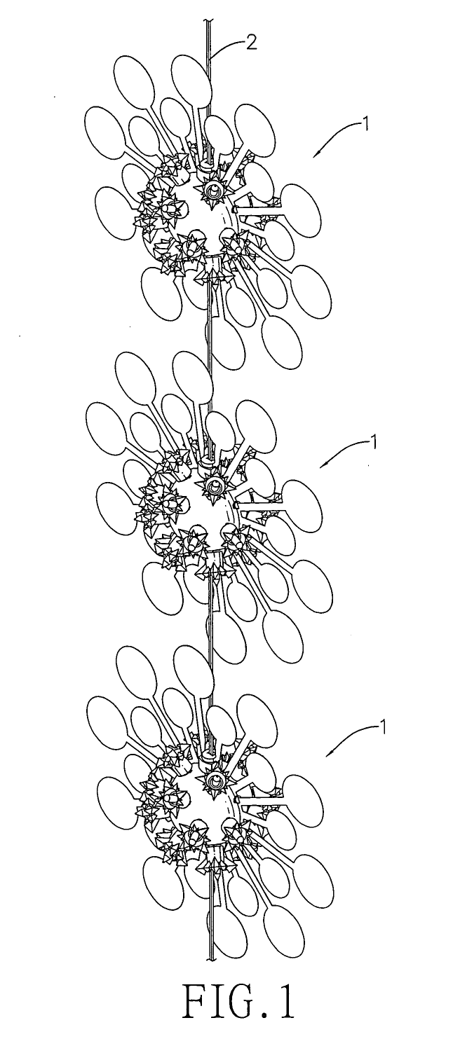

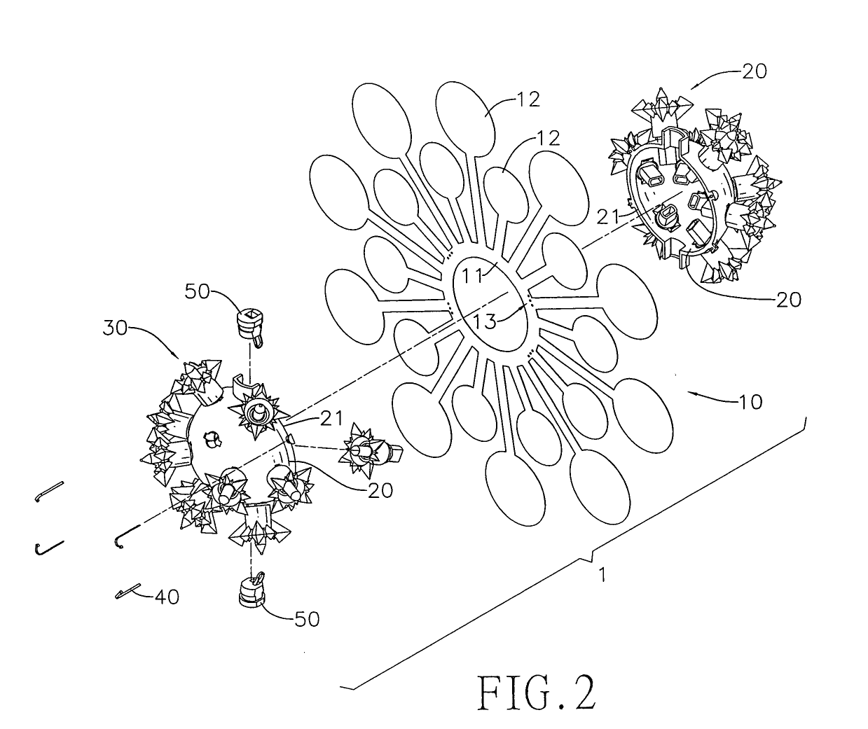

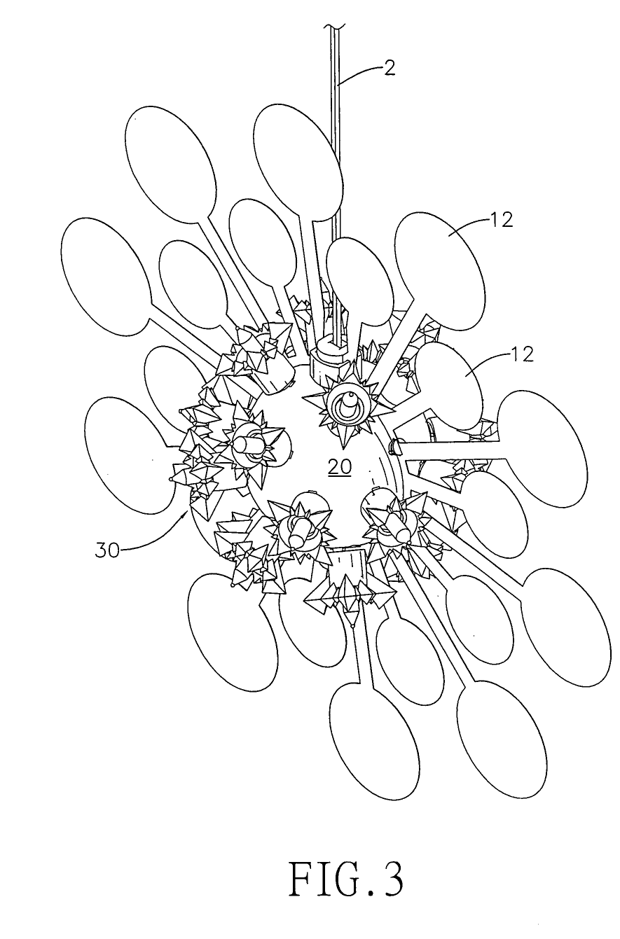

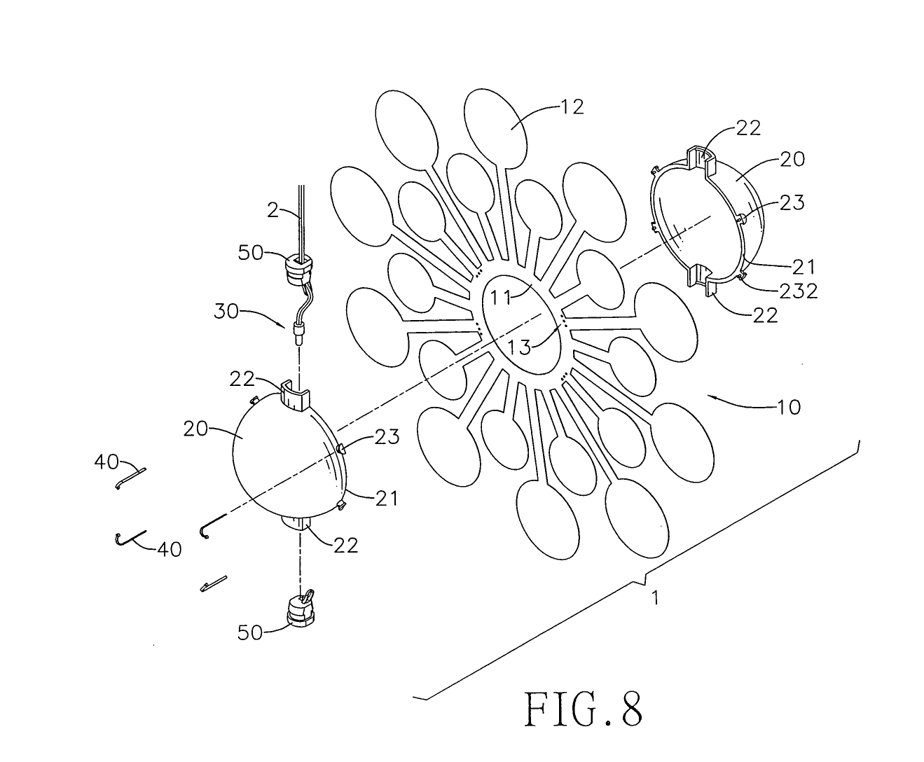

With reference to FIGS. 1, 2, 3 and 8, fairy lights in accordance with the present invention comprise at least one light assembly (1) connected to a wire cable (2). The light assembly (1) comprises a film (10) with two surfaces, two shells (20) mounted on the surfaces of the film (10) and at least one lighting device (30). Each of the light assemblies (1) may further comprise resilient clips (40) and at least one plug (50).

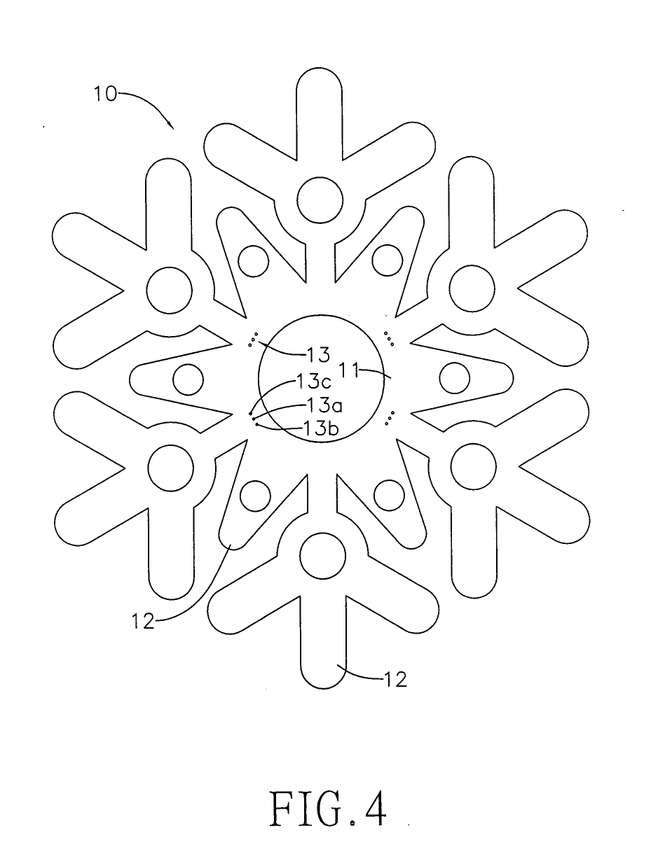

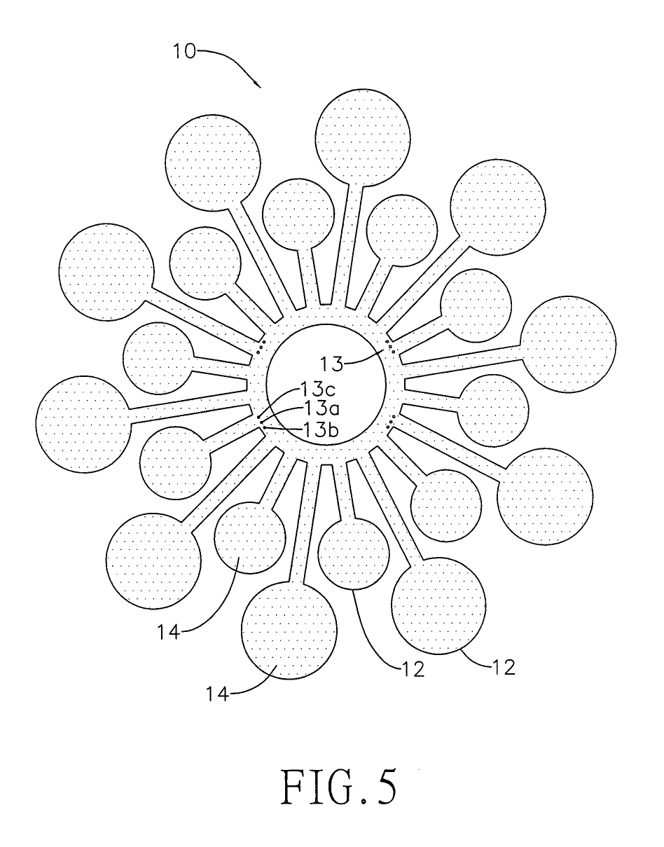

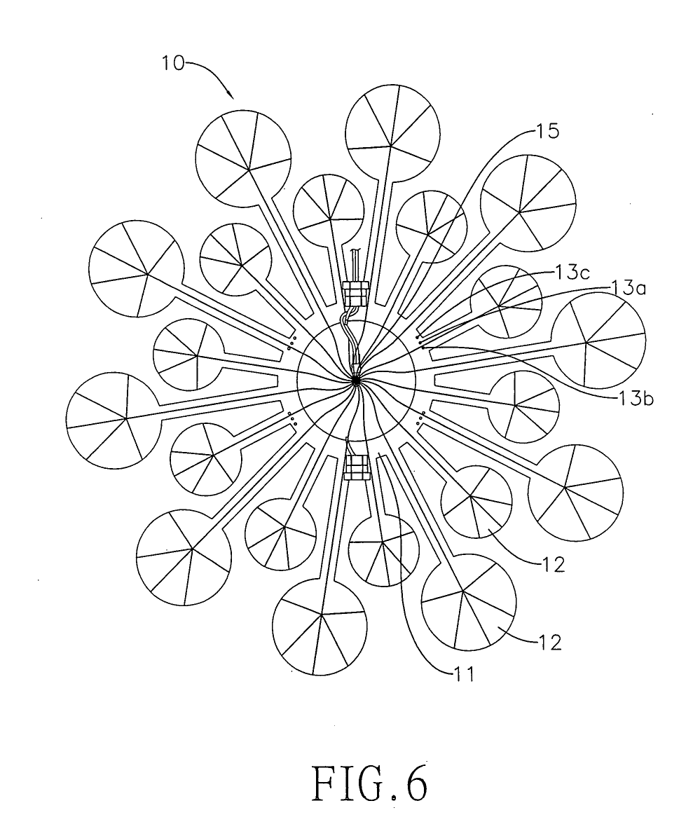

With further reference to FIGS. 4, 5 and 6, the film (10) is flexible and comprises a mounting ring (11), multiple branches (12) radially extending outward from the mounting ring (11), multiple groups of holes (13) defined through the mounting ring (11), and may comprise a reflective layer (14), a central lighting device (15), and multiple optical fibers (16). Because the film (10) is flexible, the film (10) can twist and bend slightly for additional lighting effects. Each branches (12) has a distal end.

The mounting ring (11) of the film (10) can be mounted between the shells (20) by adhering, ultrasonic welding, using suction or suck like and without using any complementary structures respectively formed on the shells (20). Alternatively, to reinforce a join between the film (10) and the shells (20), the mounting ring (11) is preferably designed to comprise a group of holes (13) mounted around a stub (232) connecting the shells (20).

Each group of the holes (13) may comprises a series of aligned holes (13a)(13b)(13c).

The film (10) can be manufactured to have a particular pattern by varying the branches (12). In the first embodiment, each of the branches (12) comprises a circular distal end and a narrow bar connected between the mounting ring (11) and the distal end.

A second embodiment of the film (10) is designed like a snowflake, the distal ends of the branches (12) being geometric patterns.

The reflective layer (14) fully, or partially coats the film (10). The reflective layer (14) of the third embodiment fully coats the film (10). A fourth embodiment comprises the central lighting device (15) and the multiple optical fibers (16). The central lighting device (15) is connected to the wire cable (2) and is mounted inside the mounting ring (11). The optical fibers (16) are respectively mounted to each branch (12). Each optical fiber (16) has a proximal end adjacent to the central lighting device (15) and a distal end mounted respectively on the distal end of each branch (12). When the central lighting device (15) emits light, the optical fibers (16) guide the light to the distal ends of each branch of the lighting assembly (1) to generate fascinating visual effects.

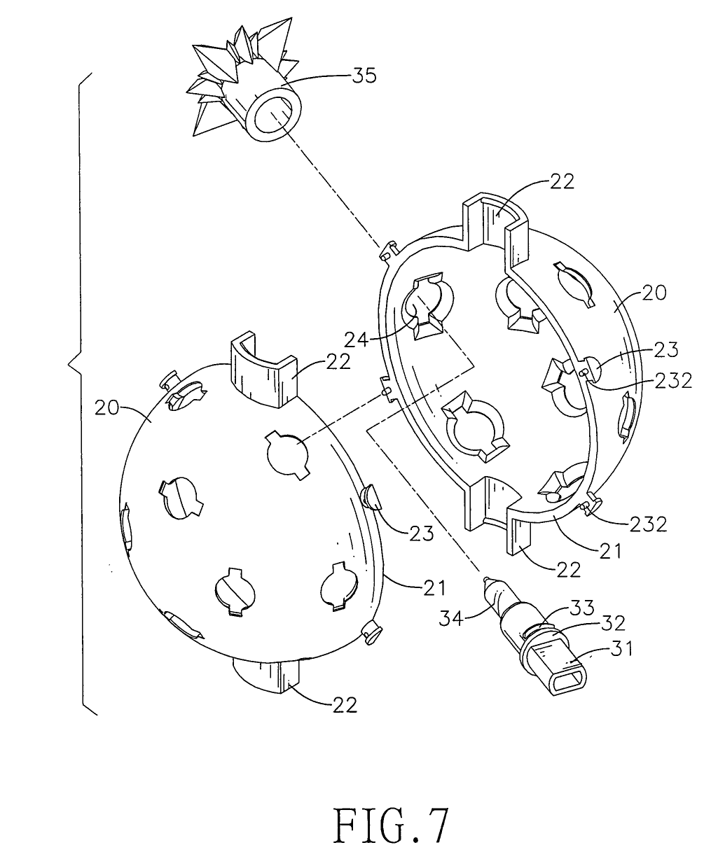

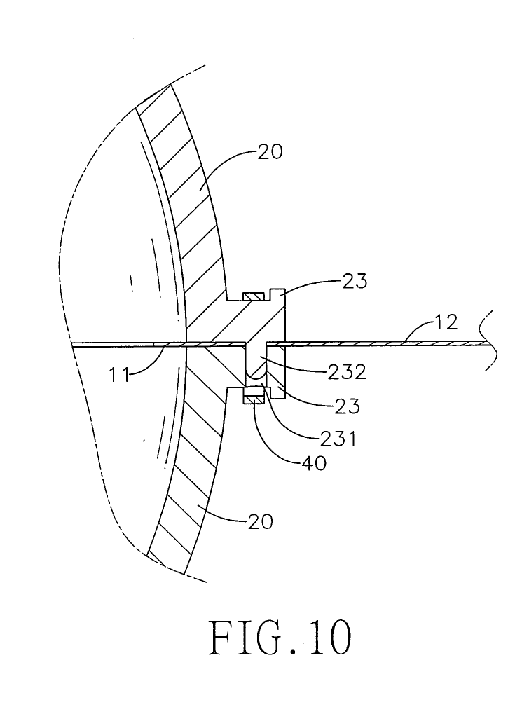

With further reference to FIGS. 7 and 10, the two shells (20) combine to form a three dimensional shape, such as a cube, a pyramid, a sphere or such like with an inner chamber. Therefore, the shells may be hemispherical and have an opening with a lip (21). Each shell (20) may comprise two mounting protrusions (22), multiple fastening protrusions (23) and multiple lamp holes (24) defined through the shell (20). The two mounting protrusions (22) extend diametrically from the lip (21).

When the two shells (10) are assembled together, a sphere may be formed and the corresponding mounting protrusions (22) form a hollow channel communicating with the inner chamber and mounted around the wire cable (2). The fastening protrusions (23) extend outward from the lip (21). The fastening protrusions (23) of one shell (20) may comprise multiple stub holes (231), corresponding to multiple stubs (232) formed on and protruding from the corresponding fastening protrusion (23) of the other shell (20), and respectively mounted in the stub holes (231). Alternatively, the fastening protrusions (23) of each shell (20) both have stub holes (231) and a stub (232) is mounted between corresponding stub holes (231).

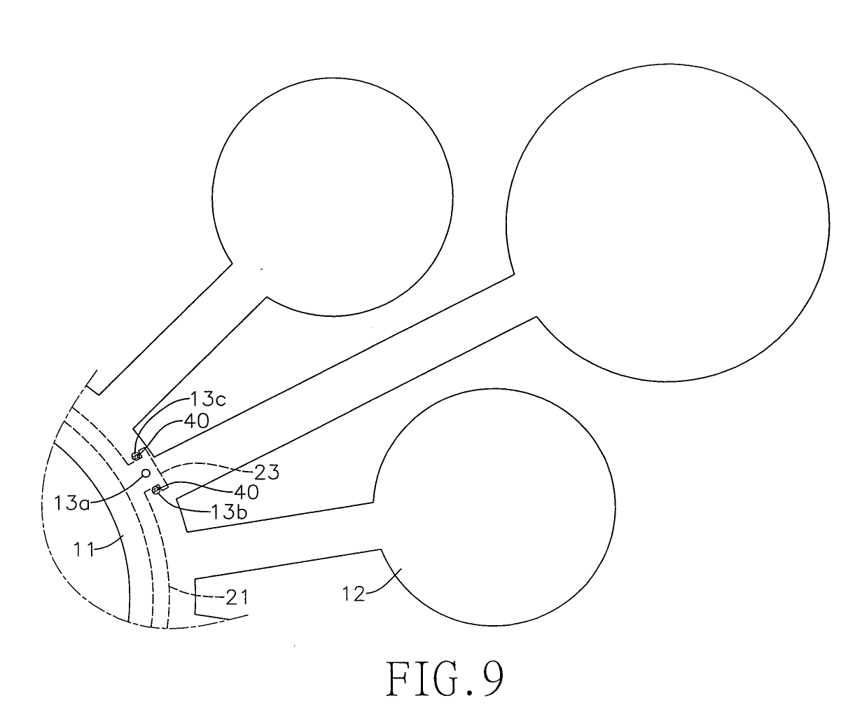

With further reference to FIG. 9, when the two shells (20) are mounted to both surfaces of the film (10), the stubs (231) extend through the holes (13a) of the mounting ring (11) of the film (10) and connect the two shells (20). The fastening protrusions (23) of the two shells (20) are reinforced by a resilient clip (40). The resilient clip (40) may be a zip-tie.

To bind the fastening protrusions (23) together, one end of the resilient clip (40) sequentially extends through one hole (13b) on the film (10), twists around one fastening protrusion (23), extends through the other hole (13c), twists around the other protrusion (23) and then eventually fixes to the other end. Therefore, the film (10) is bound together with the engaging protrusions (23).

Each shell (20) comprises multiple lamp holes (24) for respectively mounting multiple lighting devices (30). Each lamp hole (24) is formed corresponding to and holds securely each lighting device (30).

Each lighting device (30) comprises a casing (31) with an outer surface, an annular flange (32), two ribs (33), a lamp (34) and a detachable lampshade (35). The annular flange (32) is integrally formed on the outer surface of the casing (31). The two ribs (33) are diametrically formed on the outer surface of the casing (31) and apart from the flange (32) by a small distance. The lamp (34) is mounted in the casing (31). The lampshade (35) is translucent or transparent and mounted around the lamp (34).

The lighting device (30) is mounted through the lamp hole (24) of the shell (20) with the casing (31) mounted in the inner chamber of the shell (20) and the lamp (34) protruding out of the shell. Then, the lampshade (35) is mounted around the lamp (34).

The wire cable (2) may be held by the plugs (50) that are further mounted in the channels formed by the mounting protrusions (22) between the shells (20). Since the plugs (50) are mounted securely around the wire cable (2) and are mounted securely in the channels, the lighting devices (30) are protected from disconnections during handling or transportation.

The shell (20) of the second embodiment is transparent or translucent and the lighting device (30) is mounted inside the inner chamber formed by the two shells (20). Thus, the generated light from the lighting device (30) passes through the shells (20).

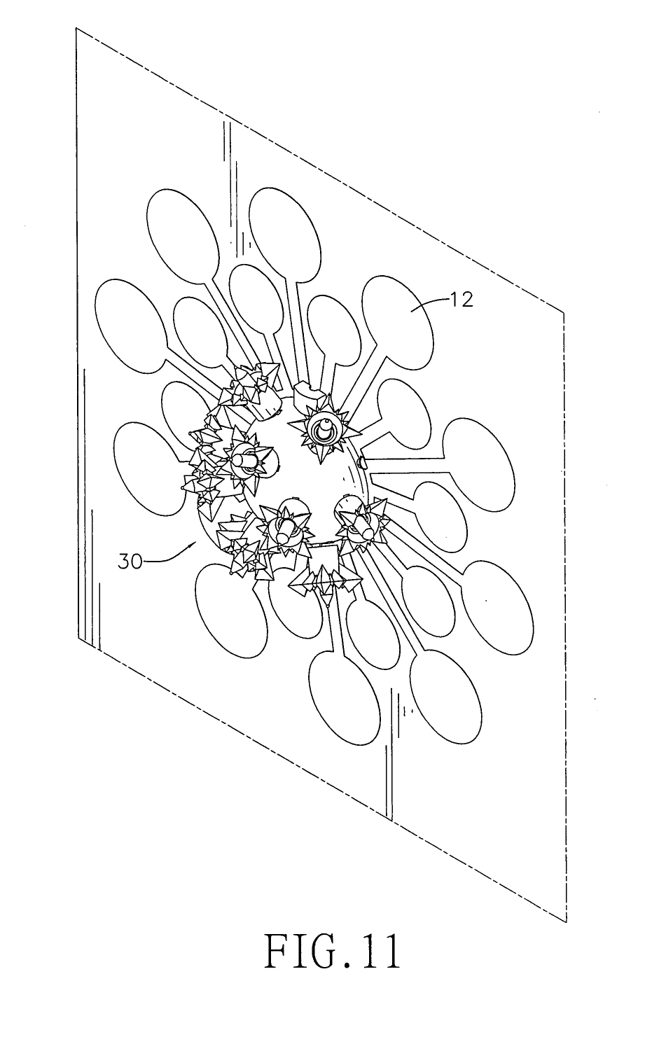

With reference to FIG. 11, the light assembly (1) of another embodiment of the present invention comprises a single shell (20), a film (10) attached to the single shell (20) and at least one lighting device (30). The light assembly (1) is suitable to be decorated on a plane such as the wall. The lighting devices (30) are mounted on the shell (20). However, the lighting devices (30) can be mounted inside the shell if the shell (20) is transparent or translucent. The foregoing described different embodiments of the film (10) in FIGS. 1-10 also can be used in this embodiment.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. f lights comprising:
at least one light assembly connected to a wire cable and comprising
a film with two surfaces and being flexible, and having
a mounting ring; and
multiple branches radially extending outward from the mounting ring, and each branch having a distal end;
at least one shell mounted on one of the two surfaces of the film; and
at least one lighting device connected to the wire cable for generating light.

2. The fairy lights as claimed in claim 1, wherein the at least one shell comprises two shells respectively mounted to the two surfaces of the film and forming an inner chamber.

3. The fairy lights as claimed in claim 1, wherein the film further comprises
a central lighting device connected to the wire cable; and
multiple optical fibers mounted on the branches, and each optical fiber having
a proximal end adjacent to the central lighting device; and
a distal end mounted on the distal end of the corresponding branch.

4. The fairy lights as claimed in claim 2, wherein the film further comprises
a central lighting device connected to the wire cable; and
multiple optical fibers mounted on the branches, and each optical fiber having
a proximal end adjacent to the central lighting device; and
a distal end mounted on the distal end of the corresponding branch.

5. The fairy lights as claimed in claim 1, wherein the film further comprises a reflective layer coating the film.

6. The fairy lights as claimed in claim 2, wherein the film further comprises a reflective layer coating the film.

7. The fairy lights as claimed in claim 4, wherein the film further comprises multiple groups of holes defined through the mounting ring; and
each shell further has
an opening with a lip;
two mounting protrusions extending diametrically from the lip and forming a channel communicating with the inner chamber when the two shells are mounted together; and
multiple fastening protrusions extending from the lip and corresponding to fastening protrusions of the other shell and one fastening protrusion comprising stub holes, whilst the corresponding fastening protrusion comprises stubs mounted in the stub holes through the holes of the film.

8. The fairy lights as claimed in claim 6, wherein the film further comprises multiple groups of holes defined through the mounting ring; and
each shell further has
an opening with a lip;
two mounting protrusions extending diametrically from the lip and forming a channel communicating with the inner chamber when the two shells are mounted together; and
multiple fastening protrusions extending from the lip and corresponding to fastening protrusions of the other shell and one fastening protrusion comprising stub holes, whilst the corresponding fastening protrusion comprises stubs mounted in the stub holes through the holes of the film.

9. The fairy lights as claimed in claim 3, wherein the at least one lighting device is mounted inside the at least one shell.

10. The fairy lights as claimed in claim 5, wherein the at least one lighting device is mounted inside the at least one shell.

11. The fairy lights as claimed in claim 3, wherein the at least one light assembly comprises multiple lighting devices mounted on the at least one shell.

12. The fairy lights as claimed in claim 7, wherein the at least one light assembly comprises multiple lighting devices mounted on the two shells.

13. The fairy lights as claimed in claim 8, wherein the at least one light assembly comprises multiple lighting devices mounted on the two shells.

14. The fairy lights as claimed in claim 7, wherein the at least one light assembly further comprises multiple resilient clips, and each group of the holes of the film includes
a hole through which one respective stub extends;
two holes through which one respective resilient clip passes and winds around the two fastening protrusions that are mounted together.

15. The fairy lights as claimed in claim 8, wherein the at least one light assembly further comprises multiple resilient clips, and each group of the holes of the film includes
a hole through which one respective stub extends;
two holes through which one respective resilient clip passes and winds around the two fastening protrusions that are mounted together.

16. The fairy lights as claimed in claim 7, wherein each light assembly further has two wire plugs that clip the wire cable and are respectively mounted in the two channels.

17. The fairy lights as claimed in claim 8, wherein each light assembly further has two wire plugs that clip the wire cable and are respectively mounted in the two channels.

18. The fairy lights as claimed in claim 12, wherein each light assembly further has two wire plugs that clip the wire cable and are respectively mounted in the two channels.

19. The fairy lights as claimed in claim 13, wherein each light assembly further has two wire plugs that clip the wire cable and are respectively mounted in the two channels.

20. The fairy lights as claimed in claim 14, wherein each light assembly further has two wire plugs that clip the wire cable and are respectively mounted in the two channels.
